(19) United States
(12) Patent Application Publication
(10) Pub. No.: US 2012/0117576 A1
(43) Pub. Date: May 10, 2012

(54) METHOD AND APPARATUS FOR OBTAINING FEEDBACK FROM A DEVICE

(75) Inventors: Tom Lam, Chula Vista, CA (US); Robert Cowie, Escondido, CA (US); Peter Tat, San Diego, CA (US); Don Nguyen, San Marcos, CA (US); Tam Dao, San Marcos, CA (US); Guoxuan Zhang, San Diego, CA (US)

(73) Assignee: Sony Corporation, Tokyo (JP)

(21) Appl. No.: 13/289,736

(22) Filed: Nov. 4, 2011

Related U.S. Application Data
(60) Provisional application No. 61/412,030, filed on Nov. 10, 2010.

(51) Int. Cl. G06F 9/46

(52) U.S. Cl. 719/328

(57) ABSTRACT

A method and apparatus for providing a user device with data based on user feedback from the user device. The method includes obtaining usage data of the user device using an application programming interface (API). A data file is generated or created based on the obtained usage data and the data file is uploaded from the user device to an external server device where data analysis of the data file is performed. The results of the analysis is used to increase user device performance.

### CLAIM TO PRIORITY

This application claims the benefit of previously filed U.S. Provisional Application 61/412,030 filed Nov. 10, 2010 entitled “VAIO Care Metrics” by Lam et al. The entirety of which is hereby incorporated by reference herein.

### BACKGROUND

1. Field of the Invention

This invention relates generally to a system and method of utilizing user feedback of a user device and more specifically to obtaining and analyzing user feedback.

2. Background Discussion

Generally, customer feedback of a user device, such as a personal computer, cell phone, PDA, television, PLAYSTATION™, PSP™ and the like, can be collected through surveys, call centers, or focus groups. Typically, conventional processing of feedback has several disadvantages. First, the customer feedback collected by this process does not have an effect on the development process since the development cycle is over by the time the machine is in the customers' hands. Second, it is too costly to conduct focus groups. It is also costly to have customers call in for software issues, for example, questions like “How do I burn a disc”, “Where do I go to find help”. Third, the manufacturer cannot directly gauge if customers are actually using their computer's software and hardware. Indeed, in many instances, when customers were asked about pre-installed device software on their computer many customers claimed to have used software that was not even installed on their device.

### SUMMARY

One embodiment of the present invention is directed to a method and apparatus for providing a user device with data based on user feedback from the user device. The method includes obtaining usage data of the user device using an application programming interface (API). A data file is generated or created based on the obtained usage data and the data file is uploaded from the user device to an external server device. Data analysis of the data file is then performed. Another embodiment of the present invention is directed to the method described above wherein data analysis identifies a speed of a wireless connection, and provides selected data, to the user device, to improve the speed of the wireless connection.

Another embodiment of the present invention is directed to the method described above wherein data analysis identifies a length of battery operational life, and provides selected data, to the user device, to improve the length of battery operational life.

Another embodiment of the present invention is directed to the method described above wherein data analysis identifies co-operation of a second device with the user device. The method further includes providing selected data, to the user device, to improve the co-operation of the second device.

Another embodiment of the present invention is directed to the method described above and also includes providing selected data, to the second device, to modify operation of the second device.

Another embodiment of the present invention is directed to the method described above and also includes providing the user device with selected data based on the data analysis.

Another embodiment of the present invention is directed to the method described above and also includes providing the user device with selected data to monitor a specified feature of the user device.

Another embodiment of the present invention is directed to the method described above and also includes determining when the specific feature monitored in the providing step reaches a predetermined threshold; and triggering a process to report the determination.

Another embodiment of the present invention is directed to the method described above wherein the determination is provided to the user device.

Another embodiment of the present invention is directed to the method described above wherein the determination is provided to a specified location.

Another embodiment of the present invention is directed to the method described above and also includes identifying a functional issue and storing data related to the functional issue. The stored data related to the functional issue is compared to previously stored data so that a response to the functional issue can be determined.

Another embodiment of the present invention is directed to the method described above and also includes obtaining second usage data after selected data is provided, to the user device, based on data analysis.

Another embodiment of the present invention is directed to the method described above and also includes creating a second data file based on the obtained second usage data and uploading the second data file from the user device to an external server device. Then performing a second data analysis of the second data file.

Another embodiment of the present invention is directed to the method described above and also includes identifying whether selected data provided to user device based on data analysis improved user device performance.

Another embodiment of the present invention is directed to the method described above and also includes providing second selected data to user device based on second data analysis.

Another embodiment of the present invention is directed to the method described above wherein the data analysis identifies a performance issue, and the selected data provided to the user device based on the data analysis is troubleshooting data, which performs a number of steps in an attempt to address the performance issue.

Another embodiment of the present invention is directed to a client device that includes a user account module that stores use pattern data for a user, the use pattern data including operational parameter data of the client device. A transmission module transmits the use pattern data to a remote location. A reception module receives processed data, the processed data being a function of the use pattern data and the operational parameter data. A processor module utilizes the processed data to modify operation of the client device based on the received processed data.

Another embodiment of the present invention is directed to the client device described above and also includes display unit that displays an indication of the operation of the client device.

Another embodiment of the present invention is directed to the client device described above, wherein the use pattern data is updated at a predetermined time interval.

Another embodiment of the present invention is directed to the client device described above, wherein the client device monitors a specified feature of the client device.

Other embodiments of the present invention include the methods described above but implemented using apparatus or programmed as computer code to be executed by one or more processors operating in conjunction with one or more electronic storage media.

### BRIEF DESCRIPTION OF THE DRAWINGS

To the accomplishment of the foregoing and related ends, certain illustrative embodiments of the invention are described herein in connection with the following description and the annexed drawings. These embodiments are indicative, however, of but a few of the various ways in which the principles of the invention may be employed and the present invention is intended to include all such aspects and their equivalents. Other advantages, embodiments and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 illustrates an example of a network that supports embodiments of the present invention.

FIG. 2 shows an example of information flow according to an embodiment of the present invention.

FIG. 3 shows a block diagram of a representative processing device.

FIG. 4 illustrates an example of usage data according to an embodiment of the present invention.

FIG. 5 illustrates an example of application usage data (AUD) in XML version according to an embodiment of the present invention.

FIG. 6 illustrates an example of system usage data (SUD) in XML version according to an embodiment of the present invention.

FIG. 7 illustrates an example of program to read and compare system usage data according to an embodiment of the present invention.

FIG. 8 illustrates an example of an AUD database according to an embodiment of the present invention.

FIG. 9 illustrates an example of a SUD database according to an embodiment of the present invention.

FIG. 10 illustrates an example of website presenting the results of data analysis according to an embodiment of the present invention.

FIG. 11 shows an example of processing usage data according to an embodiment of the present invention.

FIG. 12 shows an example of data analysis according to an embodiment of the present invention.

FIG. 13 shows an example of obtaining and selecting data according to an embodiment of the present invention.

FIG. 14 shows another example of obtaining and selecting data according to an embodiment of the present invention.

FIG. 15 shows a block diagram of a client device according to an embodiment of the present invention.

FIG. 16 shows a flowchart of steps according to an embodiment of the present invention.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from and encompassed by, the following description. As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Furthermore, the detailed description describes various embodiments of the present invention for illustration purposes and embodiments of the present invention include the methods described and may be implemented using one or more apparatus, such as processing apparatus coupled to electronic media. Embodiments of the present invention may be stored on an electronic media (electronic memory, RAM, ROM, EEPROM) or programmed as computer code (e.g., source code, object code or any suitable programming language) to be executed by one or more processors operating in conjunction with each other and/or one or more electronic storage media.

Embodiments of the present invention may be implemented using one or more processing devices, or processing modules. The processing devices, or modules, may be coupled such that portions of the processing and/or data manipulation may be performed at one or more processing devices and shared or transmitted between a plurality of processing devices or modules.

Indeed, the present invention may be implemented in a distributed or “cloud” computing environment in which shared resources, software and information are provided to computers and other devices over a network, which may be, for example, the Internet. “Cloud computing” typically involves delivering hosted services over the Internet. A cloud service typically has three distinct characteristics that differentiate it from traditional hosting. One characteristic is that it is sold on demand, typically by the minute or the hour; secondly, it is elastic—a user can have as much or as little of a service as they want at any given time; and thirdly, the service is usually fully managed by the provider (the consumer needs nothing but a personal computer and Internet access). Significant innovations in virtualization and distributed computing, as well as improved access to high-speed Internet have accelerated interest in cloud computing. The cloud can be private or public. A public cloud typically sells services to anyone on the Internet. (Currently, Amazon Web Services™ is the largest public cloud provider.) A private cloud is a proprietary network or a data center that supplies hosted services to a limited number of people. When a service provider uses public cloud resources to create their private cloud, the result is called a virtual private cloud. Private or public, the goal of cloud computing is to provide easy, scalable access to computing.

“Distributed computing”, or “distributed systems” relate to a system of multiple autonomous computers or processing devices or facilities that communicate through a network. The computers interact with each other in order to achieve a particular goal. A computer program that runs in a distributed system is typically referred to as a “distributed program” and “distributed programming” is the process of writing such programs. Distributed computing also refers to the use of distributed systems to solve computational problems. Typically, in distributed computing, a problem is divided into multiple tasks, each of which is solved by one or more computers. In general, distributed computing is any computing that involves multiple computers remote from each other that each has a role in a computation problem or information processing.

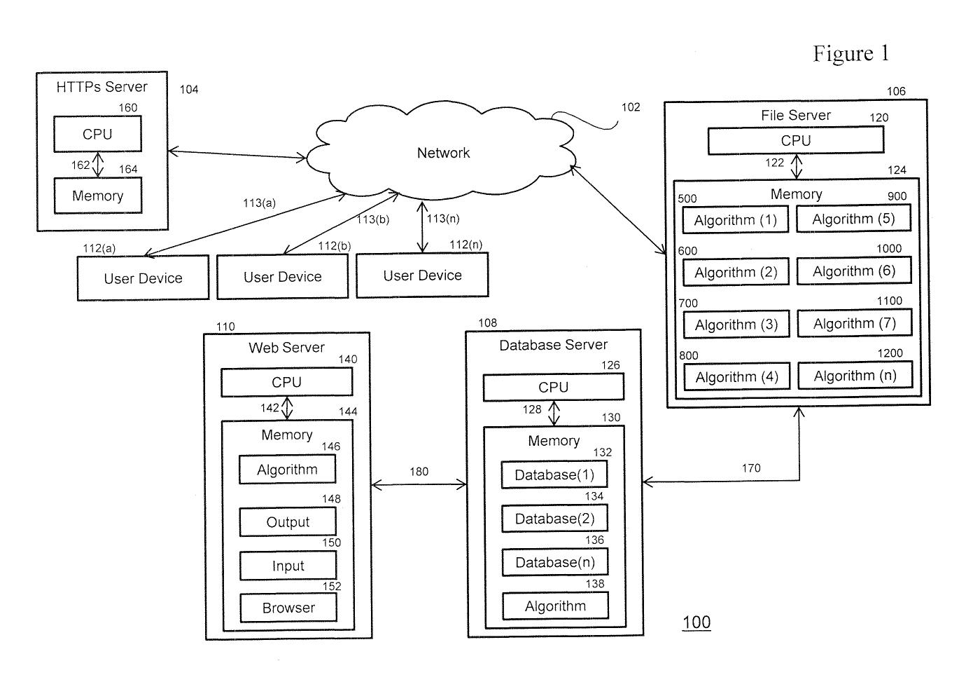

FIG. 1 shows a network environment 100 that supports embodiments of the present invention. As shown in FIG. 1, the system includes a communication network 102, an HTTPs server 104, a file server 106, a database server 108, a web server 110, and a plurality of user devices 112(a), 112(b) . . . 112(n) (where “n” is any suitable number).

The network 102 is, for example, any combination of linked computers, or processing devices, adapted to transfer and process data. The network 102 may be private Internet Protocol (IP) networks, as well as public IP networks, such as the Internet that can utilize World Wide Web (www) browsing functionality. An example of a wired network is a network that uses communication buses and MODEMS, or DSL lines, or a local area network (LAN) or a wide area network (WAN) to transmit and receive data between terminals. An example of a wireless network is a wireless LAN. Global System for Mobile Communication (GSM) is another example of a wireless network. The GSM network is divided into three major systems which are the switching system, the base station system, and the operation and support system (GSM). Also, IEEE 802.11 (Wi-Fi) is a commonly used wireless network in computer systems, which enables connection to the Internet or other machines that have Wi-Fi functionality. Wi-Fi networks broadcast radio waves that can be picked up by Wi-Fi receivers that are attached to different computers.

The HTTPs server module, or facility, or unit, 104 is typically one or more processors with associated memory, such as computers, or other processing devices such as a desktop computer and the like. The HTTPs server 104 may also be used as an external server to which gather usage data is sent from the user devices. The HTTPs server 104 includes CPU 160, which is operatively coupled to memory 164 via interconnection medium 162. The CPU 160 is a processing unit that typically includes an ALU and is configured to perform processing operations and manipulations. Memory 164 is typically an electronic storage medium that stores data in electronic format.

The file server module, or facility, or unit, 106 is typically a server, computer, or other processing devices such as a desktop computer, laptop computer, and the like. The server module 106 includes one or more processors 120 bi-directionally coupled with associated memory module 124 via wired or wireless medium 122. The memory module 124 of the file server 106 may comprise a plurality of algorithm storage modules 500, 600, 700, 800, 900, 1000, 1100 and 1200. The file server 106 may also be an internal server for processing data sent from the HTTPs server 104.

The database server module, or facility, or unit, 108 typically includes one or more processors 126 bi-directionally coupled with associated memory 130 via wired or wireless medium 128. Database server module 108 is typically a computer, server or other processing device such as a desktop computer, laptop computer, and the like. The memory 130 comprises an algorithm 138 for data analysis and a plurality of databases, database (1) 132, database (2) 134 . . . database (n) 136, (where “n” is any suitable number) for storing data. The database server 108 is used as a server for data analysis.

Similarly, the web server module, or facility, or unit, 110 typically includes one or more processors 140 bi-directionally coupled with associated memory 144 via wired or wireless medium 142. Web server module 110 includes computers, or other processing devices such as a desktop computer, laptop computer, and the like. The memory 144 comprises an algorithm 146, output means 148, such as a monitor, input means 150, such as a keyboard or mouse, and browser software 152. The web server 110 is used as a server to host and build website.

It is noted that the file server 106, the database server 108 and the web storage 110 may be a single server, and also may be implemented as one or more separate servers, which may be used in a cloud computing or distributed computing environment.

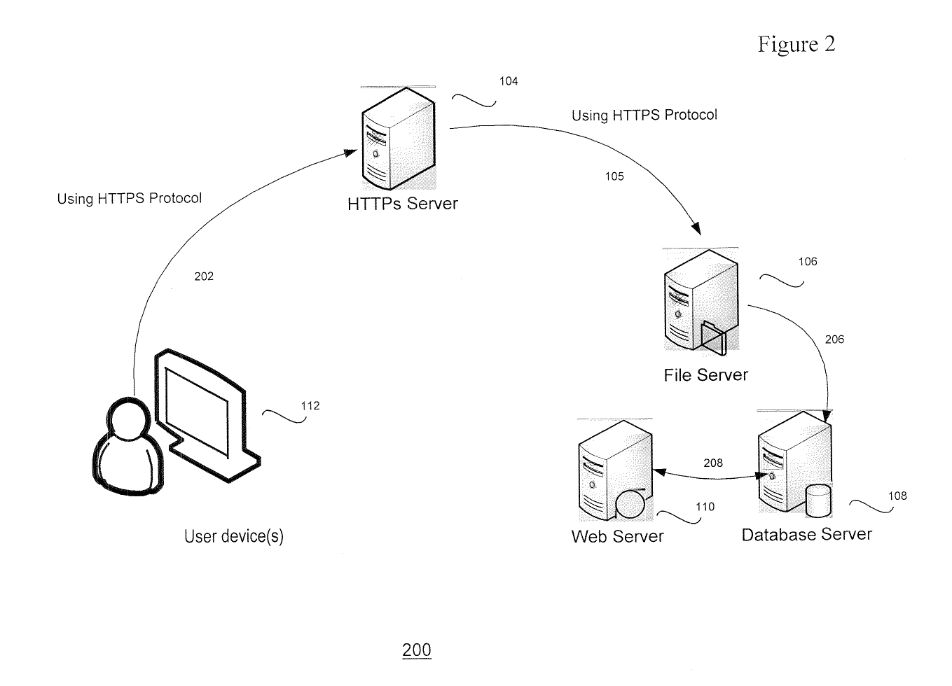

User devices 112(a), 112(b) . . . 112(n) (where “n” is any suitable number) are connected directly to the communication network 102, via associated communication medium 113(a) . . . (n). User device 112 may be any suitable consumer electronic (CE) unit or module or device. As shown in FIG. 2, the user devices may be computer products, such as a personal computer, laptop, desktop, notebook, tablet, mobile phone, PDA or other suitable computing and/or processing device or module.

The HTTPs server 104, the file server 106 and the user devices 112(a), 112(b) . . . 112(n) are coupled to network 102 via an associated bi-directional communication medium, which may be for example a serial bus such as IEEE 1394, or other wire or wireless transmission medium. Also, web server 110 is in bi-directional communication with database server 108 via communication medium 180, which may be a wire or wireless connection. Database server 108 is in bi-directional communication with file server 106 via communication medium 170, which may be a wire or wireless connection.

FIG. 2 shows an alternative network environment 200 that supports embodiments of the present invention. As shown in FIG. 2, the system includes a HTTPs server 104, a file server 106, a database server 108, and a web server 110, where the file server 106 and the database server 108 are connected via a bi-directional medium 206, and the database server 108 and web server 110 are connected via a bi-directional medium 208. The HTTPs server 104 is operatively coupled to file server 106 via interconnection medium 105, which may be a wire or wireless connection. The system 200 also includes user device 112 connected to the HTTPs Server 104 via a bi-directional medium 202 and may be connected using HTTPs protocol. While only one user device 112 is shown in FIG. 2, it is an embodiment of the present invention that a plurality of user devices 112 may be utilized.

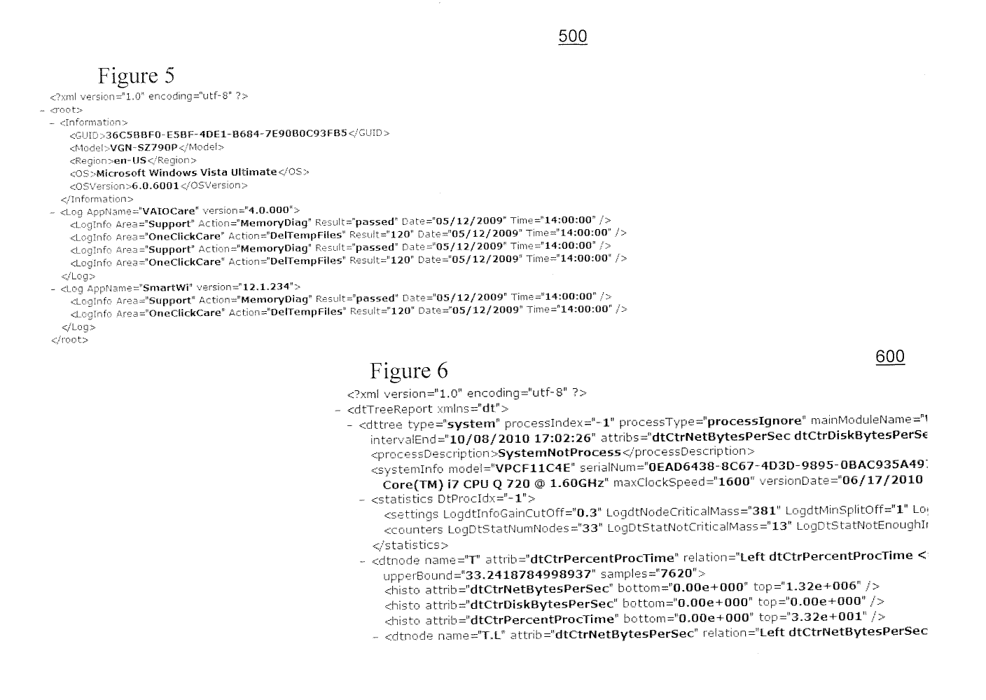

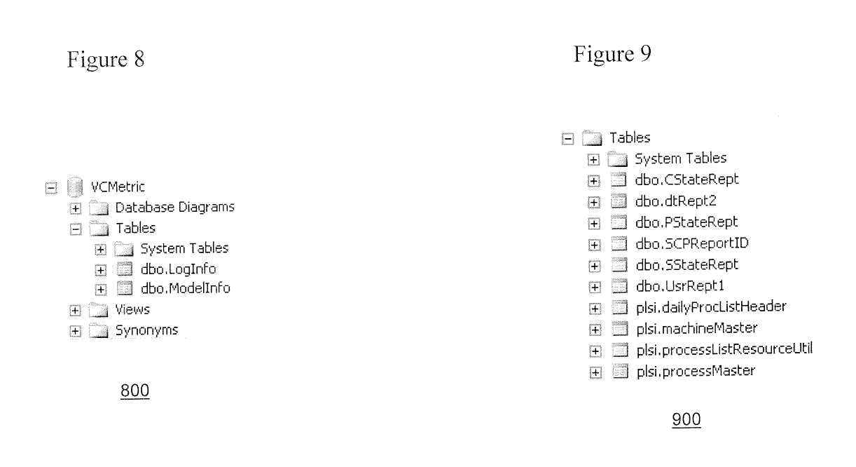

Application Usage Data (AUD) (FIG. 5) and System Usage Data (SUD) (FIG. 6) are collected at user device 112. At a predetermined time, an upload process at the user device 112 zips and encrypts the data and sends the zipped and encrypted data to the HTTPs Server 104 using HTTPS protocol 202. Again using the HTTPS protocol for secure transmission, the data is sent to the file server 106 via a communication medium 105. From there, the data is sent to the database server 108 via communication medium 206. The database server 108 comprises two core tables, which are described in more detail with respect to FIGS. 8 and 9.

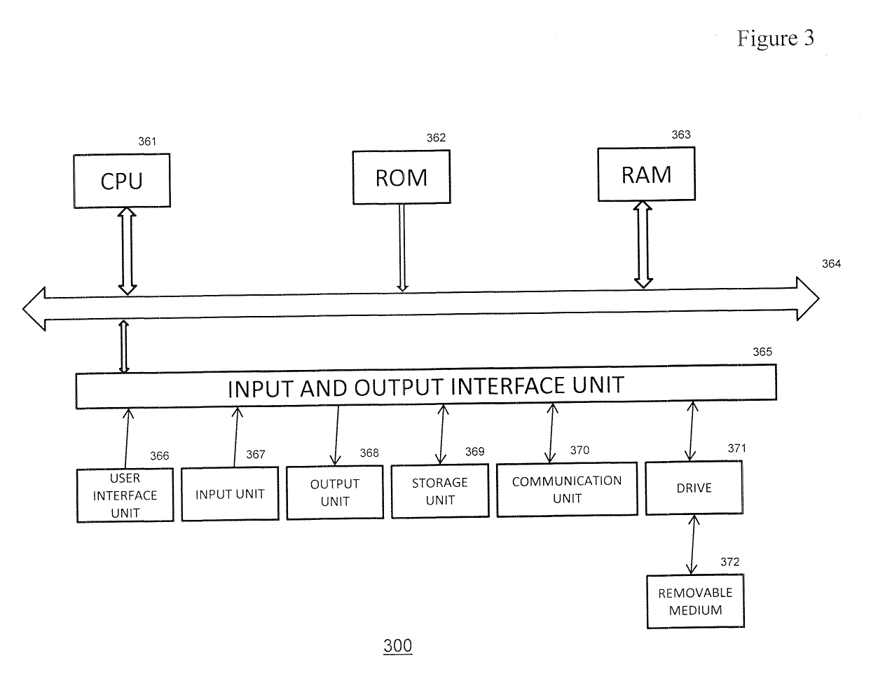

The invention disclosed herein may be practiced using programmable digital computers. FIG. 3 is a block diagram 300 of a representative computer system. The computer system 300 includes at least one processor 361, such as an Intel Core™ 2 microprocessor or a Freescale™ PowerPC™ microprocessor, coupled to a communications channel 364. The computer system 300 further includes an input and output interface unit 365. Coupled to the input and output interface unit 365 are a user interface unit 366, an input device, or unit 367 such as, e.g., a keyboard or mouse, an output device, or unit 368 such as, e.g., a CRT or LCD display, a communications unit 370, a data storage device, or unit 369 such as a magnetic disk or an optical disk, and drive 371, such as a CD-ROM, DVD-ROM, capable of reading/writing data onto a removable medium 372. Read Only Memory (ROM) 362 and Random-Access Memory (RAM) 363 are each coupled to the communications channel 364. The communications unit 370 may be coupled to a network such as the Internet. Moreover, the computer system 300 may be equipped with a browser program suitable for communication with the World Wide Web.

One skilled in the art will recognize that, although the data storage device, or unit 369 and memory 362, 363 are depicted as different units, the data storage unit 369 and memory 362, 363 can be parts of the same unit or units, and that the functions of one can be shared in whole or in part by the other, e.g., as RAM disks, virtual memory, etc. It will also be appreciated that any particular computer may have multiple components of a given type, e.g., processors 361, input devices 367, communications unit 370, etc.

The data storage device 369 and/or memory 362, 363 may store an operating system such as Microsoft Windows 7®, Windows XP® or Vista™, Linux®, Mac OS®, or Unix®. Other programs may be stored instead of or in addition to the operating system. It will be appreciated that a computer system may also be implemented on platforms and operating systems other than those mentioned. Any operating system or other program, or any part of either, may be written using one or more programming languages such as, e.g., Java®, C, C++, C#, Visual Basic®, VB.NET®, Perl, Ruby, Python, or other programming languages, possibly using object oriented design and/or coding techniques. These platforms and operating systems may be accessed in a cloud computing or distributed computing environment.

The computer system 300 may also include additional components and/or systems, such as network connections, additional memory, additional processors, network interfaces, input/output ports or busses. Also the programs and data may be received by and stored in the system in alternative ways. For example, a computer-readable storage medium (CRSM) reader, such as, e.g., a magnetic disk drive, magneto-optical drive, optical disk drive, or flash drive, may be coupled to the communications bus 364 for reading from a computer-readable storage medium (CRSM) such as, e.g., a magnetic disk, a magneto-optical disk, an optical disk, or flash RAM. Accordingly, the computer system 300 may receive programs and/or data via the CRSM reader. Further, it will be appreciated that the term “memory” herein is intended to include various types of suitable data storage media, whether permanent or temporary, such as transitory electronic memories, non-transitory computer-readable medium and/or computer-writable medium.

Two or more computer systems 300 may be connected, e.g., in one or more networks, via, e.g., their respective communications interfaces and/or network interfaces (not depicted).

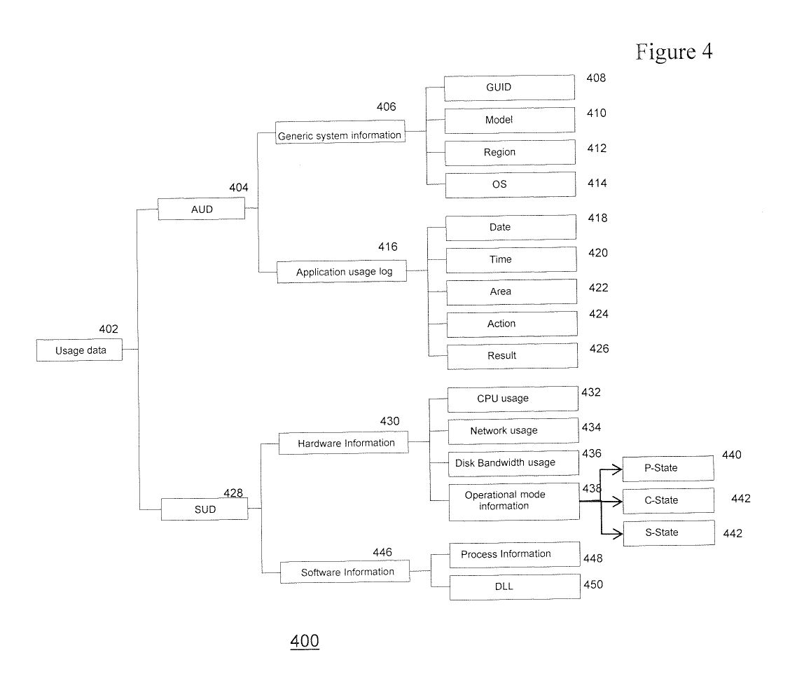

FIG. 4 illustrates an example 400 of usage data 402 according to an embodiment of the present invention. Usage data 402 is broken down into two types of data, Application Usage Data (AUD) 404 and System Usage Data (SUD) 428.

AUD 404 is comprised of Generic System information 406 and an Application Usage Log 416. The Generic System Information 406 is comprised of a randomly generated ID for the system called a Globally Unique Identifier (GUID) 408 which allows the system to maintain a history of data recorded on a computer without reporting any personal identifiable information this maintaining user privacy, model information 410, which is the model of the system, region information 412, which includes information on what language the user of the system selected, and OS information 414, which includes what operating system and what version of that operating system that the system is running.

The Application Usage Log 416 comprises date information 418, time information 420, area information 42, which includes data indicating where an action occurred, action information 424, which includes data on what action occurred, e.g. a click, and result information 426, which includes data indicating the result from the action.

SUD 428 is comprised of Hardware information 430 and Software information 446. Hardware information 430 comprises CPU usage data 432, network usage data 434, disk bandwidth data 436, and operation mode information 438. The operation mode information may comprise P-State information 440 indicating the voltage and frequency of the CPU, C-State information 442 indicating which of several included power state modes that the CPU is operating in, and S-State information 444 indicating a system in Standby/Sleep/Hibernate mode.

The software information 446 comprises Process Information 448, which comprises a list of all processes ran on the system, their descriptions, when it was ran, how much CPU, Disk, and Network bandwidth was used, and how often it was used. The software information 446 further comprises DLL information 450, which is a list of all DLLs associated with each process, their descriptions, when it was run, how much CPU, Disk, and Network bandwidth was used and how often it was used.

FIG. 5 illustrates an example 500 of application usage data (AUD) in XML version according to an embodiment of the present invention. The XML is used to track all clicks of user input and allow data mining to summarize which features are used or unused.

FIG. 6 illustrates an example 600 of system usage data (SUD) in XML version according to an embodiment of the present invention. In one embodiment, the code for SUD is written in native C++, the program has minimal impact on the system ecosystem (operating speed, processor capacity utilized, power consumption, memory space utilized etc.). A program is written to translate the XML of the AUD data into a readable format that can be used for analysis.

After the Application Usage Data (AUD) and System Usage Data (SUD) are gathered, an upload process zips and encrypts a data file. The data file is then transmitted using HTTPS protocol for secure transaction. The zipping, encrypting, and uploading can be written as generic code so that other applications may use the same methods. AUD and SUD may be sent to the file server at any predetermined or requested time. For example, AUD may be sent to the file server once per month and SUD may be sent to the file server once per week.

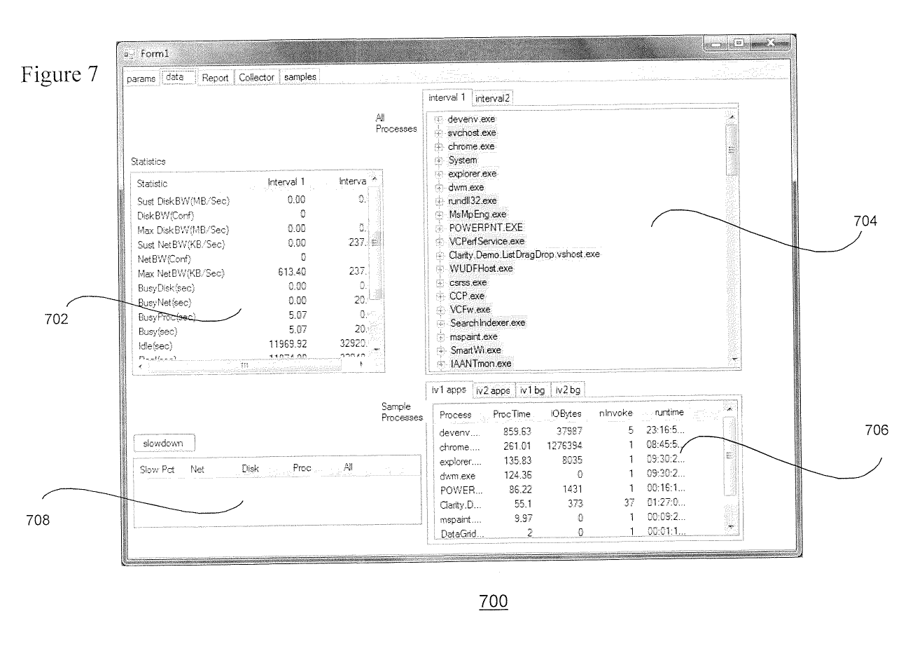

FIG. 7 illustrates an example 700 of program code to read and compare SUD according to an embodiment of the present invention. In FIG. 7, portion 702 shows hardware information, portion 704 shows software information, portion 706 shows sample processes and portion 708 shows a menu.

Portion 702 shows an example of statistics. This is illustrated as three columns of “statistic” “interval 1” and “interval 2”. The statistic column lists various categories, such as “Sust Disk BW(MB/sec)”; “Disk BW (conf)”; “Max Disk BW(MB/Sec)”; “Sust NetBW(KB/Sec)” and others, as shown in area 702.

Portion 704 shows a list of processes that may be executed. As shown in portion 704, these may include “devenv.exe”; “svchost.exe”; “chrome.exe”; “System” and others, as shown in portion 704. The software information 704 may be organized with different color highlighting. For example, green highlights may indicate user launch processes, pink highlights may indicate system processes, and blue highlights may indicate unknown processes.

Portion 706 shows sample processes. This includes, for example, a listing of a “process”, “process time”, “i0Bytes”, “nInvoke”; “runtime”. The “process” list includes sample processes of the portion 704.

Portion 708 shows a menu sub-screen with headings “Slow Pct”; “Net”; “Disk”; “Proc” and “All”. Additional headings may also be used in portion 708.

FIG. 8 illustrates an example of AUD database 800 according to an embodiment of the present invention. As shown in FIG. 8, various files and folders are displayed.

FIG. 9 illustrates an example of SUD database 900 according to an embodiment of the present invention. The SUD data includes folders and sub folders that can be accessed.

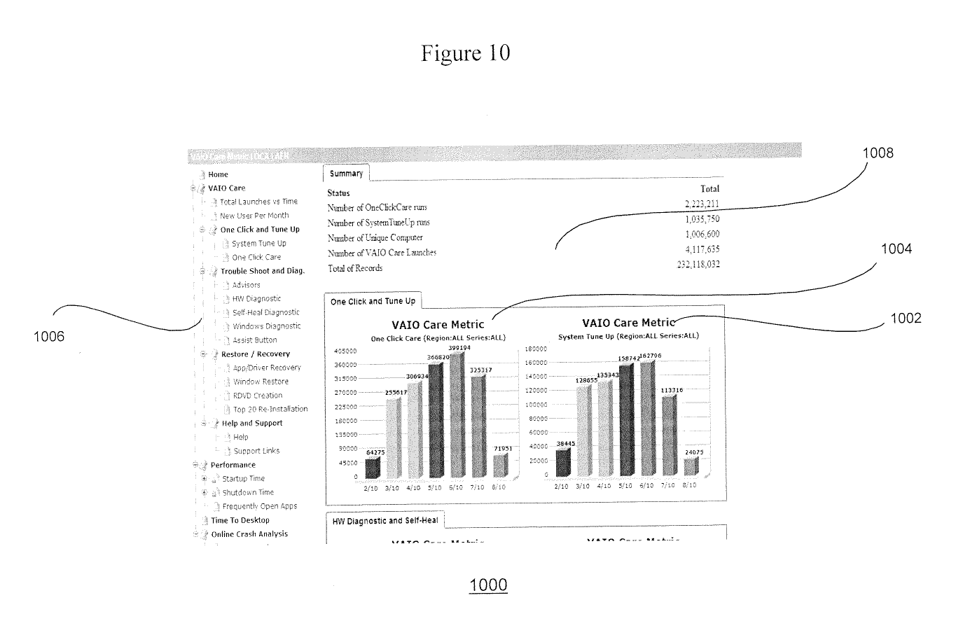

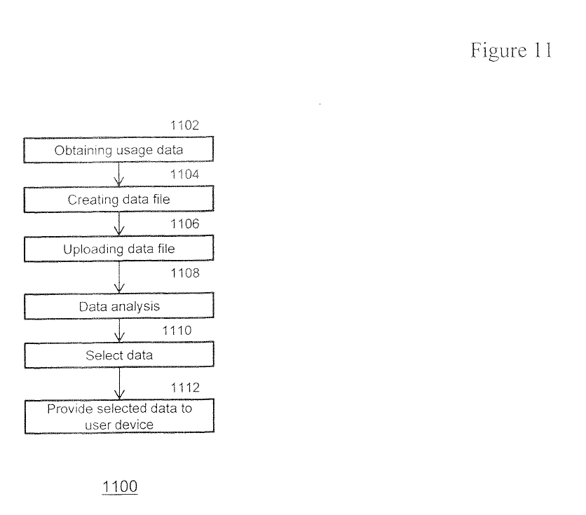

FIG. 10 illustrates an example 1000 of a display, such as a webpage of a website that presents the results of data analysis according to an embodiment of the present invention. To analyze data stored in the databases, one or more processors may be used, functioning together and/or separately (local or remote), for example in a cloud computing or distributed computing environment, to process or manipulate data obtained about device usage. This data may be displayed on a webpage of a website. When a query is performed, by an operator, using the website, data may be requested from the web server (shown in FIG. 1 as element 110) to the database server (shown in FIG. 1 as element 108). One embodiment of a suitable webpage is shown in FIG. 10 as web page display 1000. This web page display 1000 includes an area to display graphical representations 1002, 1004; folder portion 1006 and summary portion 1008.

Portion 1002 and 1004 is an area used to display graphical representations. Specifically, graphical representations 1002 and 1004 illustrate a pictorial representation of collected data.

Portion 1008 shows a summary area that provides a display or output in tabulated, or written form.

Portion 1006 shows a listing a various folders and categories of the system, as described herein. These categories include, for example, “One Click and Tune Up”; “Trouble Shoot and Diag.”; “Restore/Recovery”; “Help and Support”; “Performance”; “Time To Desktop”; “Online Crash Analysis” etc.

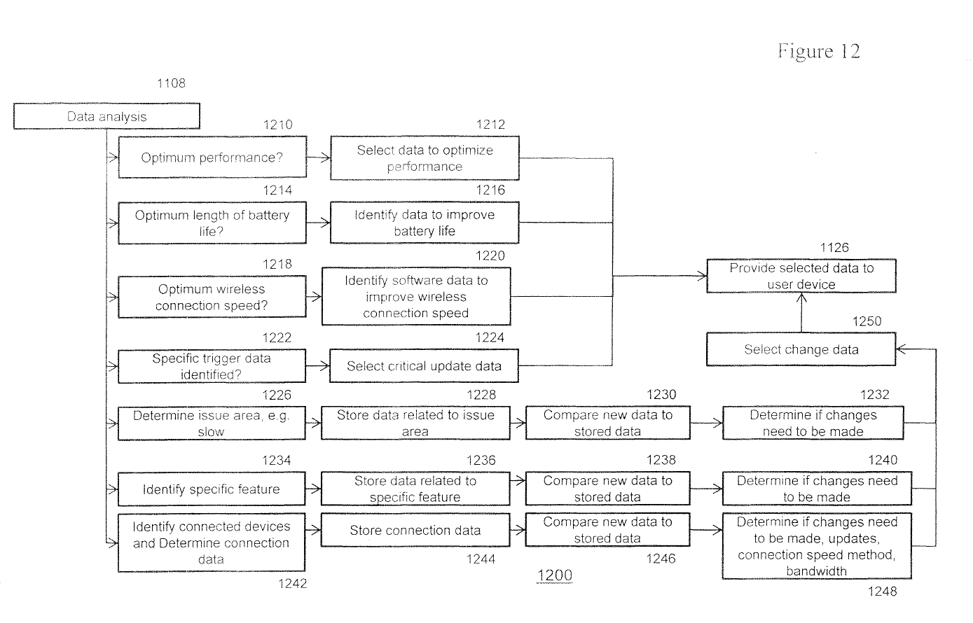

FIG. 11 shows a sample process 1100 of an embodiment of the present invention. As shown in FIG. 11, the process 1100 first obtains usage data from the user device, as shown in step 1102. Next, a data file is created, as shown in step 1104. The data file is then uploaded, as shown in step 1106. Before being uploaded the date file may be encrypted and zipped. Once the file is uploaded to an external server via a network, data analysis is done on the date file, as shown in step 1108. Typically this data analysis is performed in one or more of the module shown in FIGS. 1 and 2 herein. For example the database server 108 of FIG. 1 and/or the file server 106 of FIG. 1. These elements are also shown in FIG. 2 herein.

Data analysis may be performed on any portion of the data. Data analysis may be used to identify data related to any function of the user device, e.g. input or output devices, memory, display devices, and data that alter the performance of any function may be selected in response to the data analysis, as shown in step 1110. Once data analysis is complete or after data is selected in the data analysis, the process moves to step 1112, where the selected data is provided to the user device. The data that is provided to the user device may be used to update software, increase hardware functionality by updating memory registers or any other operation that causes the user device to operate more efficiently.

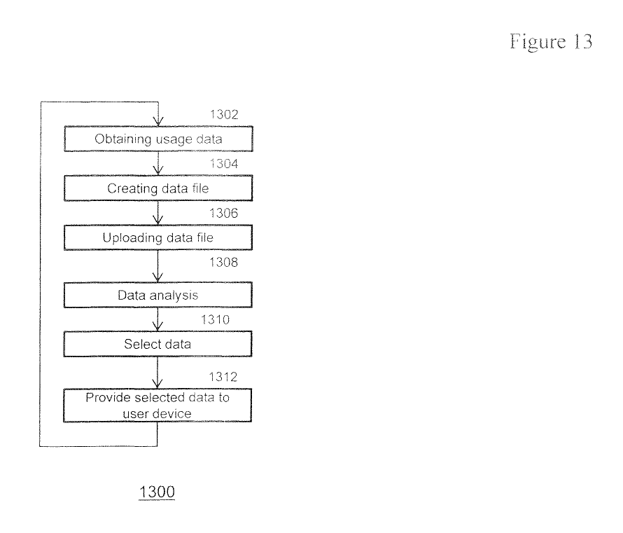

FIG. 12 is another embodiment of the present invention. FIG. 12 shows a process 1200 expanding the data analysis step 1108 of FIG. 11 through the step of selecting data in response to data analysis 1110. Data analysis may be used for a plurality of functions. In step 1210, the data file is analyzed to determine whether the user device is at optimum performance. If the user device is found to not be operating at optimum performance, data is selected to improve performance in step 1212. Data that may be selected to improve performance may include software programs that may be installed, software updates, directions to remove existing software or data on the user device.

Data analysis may also determine the battery operational life length or whether the battery operating life may be improved, as shown in step 1214. In step 1216, data is identified that may improve the operating life of the battery. Data analysis may determine connection speed and determine whether connections speed may be improved, as shown in step 1218. In step 1220, data is selected that may improve wireless connection speed.

In step 1222, data analysis identifies specific data from the data file. Specific data may be what version of a software program is being used, or specific trigger data that indicate a need for an update. If the specific data is identified in step 1222, critical update data is selected in step 1224.

Additionally, data analysis may identify or determine an issue area in step 1226, such as a piece of hardware of software not running correctly or in an optimum or acceptable performance level. In step 1228, data related to the identified issue area is stored. When data related to the issue area has been identified or stored at a previous time, the new data related to the issue area and data previously stored is compared, as shown in step 1230. In step 1232, the process determines what changes, if any, should be made. Change data related to any changes determined are selected, as shown in step 1250.

In an alternative embodiment, change data may include software that when installed, monitors specified data. When a predetermined threshold or change is monitored in the specified data, a data file is created and uploaded.

FIG. 12 further shows that data analysis may identify data related to a specific feature in step 1234. For example, the current speed of the wireless connection or available processing power of the processor in an operational certain state (i.e., operating, sleeping, “on” “off” and/or the current state of data registers, ALU, memory and circuit components). Data related to the specific feature, such as, for example, the exact processing power of the processor in a power saving mode, is stored in step 1236. In step 1238, the newly stored data is compared to data that has been previously stored. The process then determines what, if any, changes need to be made in step 1240. These changes may be made to increase processor efficiency, update software or hardware or connections or other CPU operation. Change data related to any changes determined are selected as shown in step 1250.

Furthermore, data analysis may identify connected devices to the user device in the data analysis, in step 1242. In addition to determining what devices are connected or have been connected to the user device, the process may identify data related to the connection. For example, data analysis may determine that the user device often connects to a MP3®, DVD, or Blu-Ray® player, and may determine the USB bus speed of the download of data and the upload of data from the connected devices.

Also, the data analysis may indicate that the user account has one or more additional devices, such as for example, a second Blu-Ray® device associated with the user account. The data analysis can include providing information to increase the efficiency of the two Blu-Ray® players interaction. Also, the information may include update information related to other electronic devices (secondary devices) associated with a single user account. Thus, one embodiment of the present invention increases the intelligence by providing updates and modifications to devices other than the device that a user is currently, or actively, using. This is done when the server provides update data to the secondary devices.

In step 1244, the data is stored. In step 1246, the newly stored data is compared to data that has been previously stored. The process then determines what, if any, changes should be made, as shown in step 1248. These changes may include software, updates, or connections settings on the user device or on the connected device. For example, the process may determine that a decrease in upload speed from the user device a Blu-Ray® player is related to a user adjustable setting on the Blu-Ray® player.

Data is then selected in step 1250 and provided to the user device in step 1126. Where the selected data is software, an update, or a change in an adjustable setting on the connected the device, the selected data will be transferred to the connected device when the user device next connects to the connected device. For example, where data is provided to the use device to install or update software or change an adjustable setting on a Blu-Ray® player, the data is stored on the user device until connection is made to the Blu-Ray® player. Upon connection, the data is sent to the Blu-Ray® player and the change is affected. If the connection does not last long enough for the transfer to be made, the data continues to be stored on the user device until the next connection.

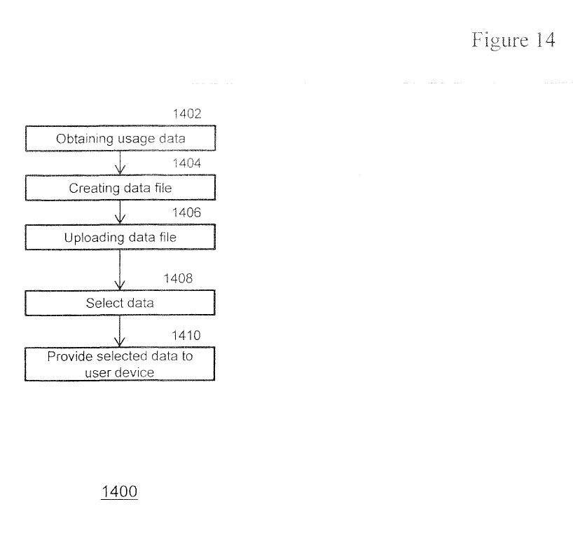

FIG. 13 shows another embodiment of the present invention. In process 1300, usage data is obtained from the user device, as shown in step 1302. Next, a data file is created, as shown in step 1304. The data file is then uploaded, as shown in step 1306. The data file may be uploaded to a database server, file server or HTTPs server, as described herein. Before being uploaded the date file may be encrypted and zipped. Once the file is uploaded to an external server via a network, data analysis is done on the date file, as shown in step 1308. In step 1310, data is selected in response to the data analysis.

Data analysis may be used to identify data related to any function of the user device, e.g. input or output devices, memory, display devices, and data that alter the performance of any function may be selected in response to the data analysis.

Once data analysis is performed and data is selected according to the data analysis, the process, as shown in step 1312. Since additional data analysis of a different set of data may be desired, the process then may proceed to step 1302 and obtain additional usage data. Specific usage data may be obtained. The specific usage data is related to the results of the data analysis and the results of the selected data on the data analysis. For example, if the data analysis step 1308 identifies a critical update is needed and a critical patch needed is selected in step 1310 and provided to the user device in step 1312, the second data obtaining step may obtain only data related to the critical pitch, the delivery of the critical patch, the installation of the critical patch, the performance of the system, or any combination thereof.

Alternatively, the second data obtaining step may collect data as usual, and only related data may be put in the second data file created. Alternatively, data may be collected as usual, and the data file may be created and uploaded as usual, but only the related data may be analyzed.

FIG. 14 shows another embodiment of the present invention. In process 1400, usage data is obtained from the user device, as shown in 1402. Next, a data file is created in step 1404. The data file is then uploaded in step 1406. The data file may be uploaded to a database server, file server or HTTPs server, as described herein. Before being uploaded the date file may be encrypted and/or zipped. Once the file is uploaded to an external server via a network, data is selected to be provided, as shown in step 1408 without any data analysis being done. For example, when a data file for new user device is received, specific data may be sent to the new user device before any analysis can or will be done, such as identity checking, payment information, a general information request, or specific software that is needed or would help in future usage data collection or data file creation. As shown in step 1410, the selected data is provided to a user device. The user device may then utilize all or a portion the selected data to modify operation of the user device.

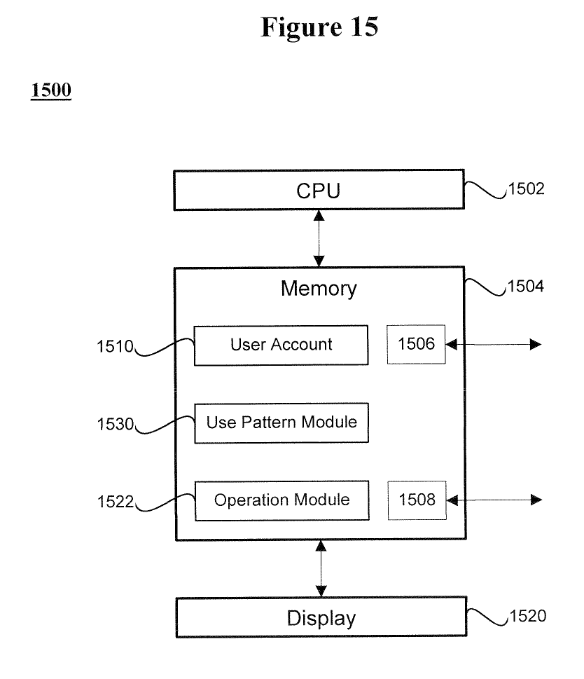

FIG. 15 shows a block diagram 1500 of a client device according to an embodiment of the present invention. (The client device is also shown in FIG. 2 as element 112.) The client device 1500, as shown in FIG. 15, includes a processor module 1502 (shown as CPU) and a memory module 1504. The memory module 1504 includes a user account module 1510 that stores user information, such as PIN, password, device identifier, serial number and other user and/or device information. Use Pattern module 1530 is used to store use pattern data for a user. This may include, for example, software operating on the device, internet sites visited, mode of operation, key strokes, troubleshooting algorithms run, requests for help, or emails to help desks or hot lines, memory use, types of programs executed (i.e., word processing, research, financial planning, spread sheets, etc.) and other information related to a particular user. Indeed, more than one user may be associated with a device and thus have an individual user account. The operation module 1522 is also used to store operational data about the device 1500. The operation module 1522 also includes memory locations that can store upgrade information and operational parameter information (i.e., inter-device connection mode, inter-device connection speed, or other information related to how the client device operates and/or functions) and/or additional components (hardware and/or software) that will be responsive to the type of use of the device and/or programs executed by the device. Thus, a particular user may find it helpful to receive upgrades and/or recommendations for upgrades based on the type of use and functions they are executing with their client device for more efficient operation of their client device 1500.

Transmission module 1506 transmits the use pattern data to a remote location. The remote location may be one or more of remote devices, such as one or more of the server devices (104, 106, 108, and/or 10) shown in FIG. 1.

A reception module 1508 receives processed data, the processed data including processed operational parameter data. The processed data may identify one or more device functions that may be enhanced, upgraded or modified.

The processor module (CPU) 1502 utilizes the processed data, including the CPU recommendations and/or CPU upgrade data to modify operation of the client device. Display module 1520, which may be an LCD, plasma, CRT or other suitable display device that can display text and/or image data, displays an indication of the received processed data and displays an indication of the modified operation of the client device, and/or recommendations or a combination thereof. The modified operation may include, for example, what software is operating on the client device, the CPU operating conditions, memory allocation, troubleshooting routines, anti-virus software and other hardware and/or software operations of the client device.

Thus, a user at a client device, or terminal, 1500 can receive an indication of how their device operation has been modified based on the processed use data and what recommendations are being generated based on the use pattern data. This indication may also include device parameters and/or functions that have been optimized and parameters and/or functions that have not been optimized. It can also indicate the status of one or more troubleshooting routines or algorithms. The troubleshooting routines may be updated and/or modified based on additional use pattern data that is acquired subsequent to execution of a previous troubleshooting routine.

The use pattern data may be updated at a predetermined time interval, such as every 24 hours, every month or after new software and/or hardware has been introduced. Thus, the use pattern data module is iterative by updating the use pattern data of the device at a predetermined time interval and/or operational status.

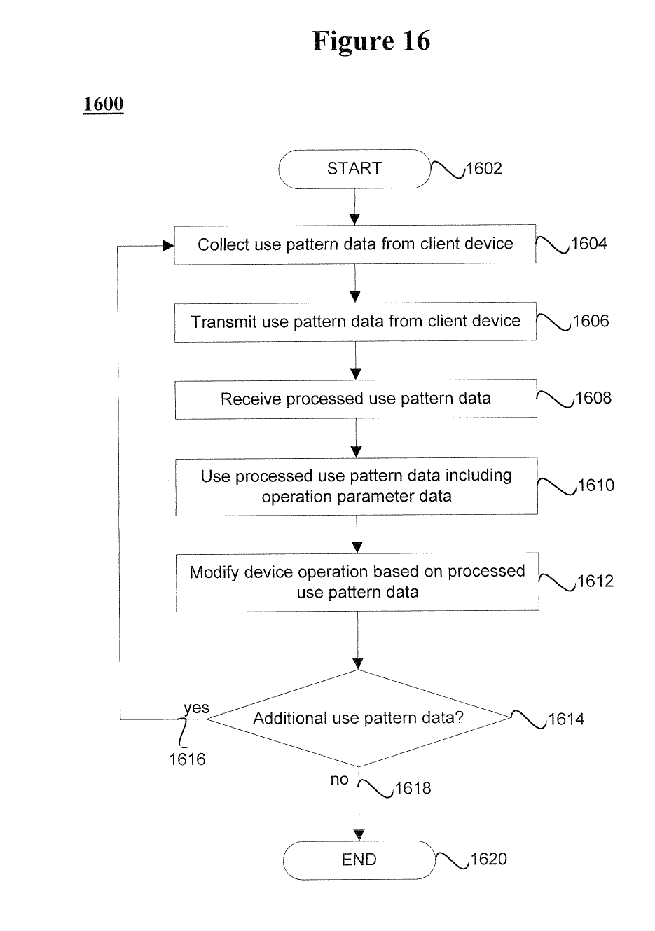

FIG. 16 shows a flowchart of steps 1600 according to an embodiment of the present invention. The steps 1600 may be stored on a suitable electronic storage medium, such as a computer-readable medium. The flowchart may be stored in a storage location, which may be any of the memory locations described herein in File Server, Data Base Server, HTTPs server, or other remote or local memory in a client device. The steps may be stored on a non-transitory computer-readable medium, or any suitable electronic storage medium or may be retrieved from a remote location. Steps 1600 begin with start step 1602. Use pattern data is collected from the client device, as shown in step 1604. The collected use pattern data, that has been collected by the user device is transmitted from the client device to a remote location, such as the servers shown in FIG. 1, as shown in step 1606. The client device may then receive processed use pattern data from a remote location, as shown in step 1608. The processed use pattern device data is based on the use pattern data that was collected by the device. The processed use pattern data may also identify one or more ways to upgrade and/or modify operation of the CPU. For example, if the use pattern data shows particular CPU operational states, a recommendation for more efficient CPU functionality may be generated. This recommendation may reflect software operating on the client device, hardware components, memory usage and other characteristics of the user using the client device. The recommendation may be transmitted to the user as well as further processed to generate recommendations for a particular user, or a class of users (e.g., all users of a particular model of client device).

The processed use pattern data includes operational parameter data information may then be used to modify operation of the client device and/or provide recommendations, as shown in step 1610 and step 1612. This modification may include retrieving additional software, suggesting additional software upgrades, suggesting additional hardware upgrades, changing the operational status of the device, troubleshooting, downloading one or more software patches, or other modification or recommendation based on the received processed data.

The result of the processed data and/or recommendations may be displayed on a display device. This may include displaying a message regarding software upgrades, hardware upgrades, optimization of one or more device parameters, such as CPU operation, detected virus, anti-virus software or other messages and/or recommendation to a user to improve operation of the device or suggest a more suitable device or other additional devices that the user may find enhance the computing experience.

In step 1614, a determination is made whether there is any additional use pattern data. This includes use pattern data that has been generated since the previous collection of use pattern data or use pattern data that results from modified operation of the device and/or additional software/hardware. If there is additional use pattern data, “yes” line 1616 leads to step 1604 and the process repeats, as described above. If there is no additional use pattern data, “no” line 1618 leads to end step 1620.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof In one embodiment, the present invention can be implemented in software as an application program tangible embodied on a computer readable program storage device. The application program can be uploaded to, and executed by, a machine comprising any suitable architecture.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

What Is Claimed Is:

1. A method for providing a user device with data based on user feedback from the user device, comprising:
obtaining usage data of the user device using an application programming interface (API);
creating a data file based on the obtained usage data;
uploading the data file from the user device to an external server device; and
performing data analysis of the data file.

2. The method as claimed in claim 1,
wherein data analysis identifies a speed of a wireless connection, and
further comprising the step of:
providing selected data, to the user device, to improve the speed of the wireless connection.

3. The method as claimed in claim 1,
wherein data analysis identifies a length of battery operational life, and
further comprising the step of:
providing selected data, to the user device, to improve the length of battery operational life.

4. The method as claimed in claim 1,
wherein data analysis identifies co-operation of a second device with the user device, and
further comprising the step of:
providing selected data, to the user device, to improve the co-operation of the second device.

5. The method as claimed in claim 4, further comprising:
providing selected data, to the second device, to modify operation of the second device.

6. The method as claimed in claim 1, further comprising the step of:
providing the user device with selected data based on the data analysis.

7. The method as claimed in claim 1, further comprising the step of:
providing the user device with selected data to monitor a specified feature of the user device.

8. The method as claimed in claim 7, further comprising the step of:
determining when the specific feature monitored in the providing step reaches a predetermined threshold; and
triggering a process to report the determination.

9. The method as claimed in claim 8, wherein the determination is provided to the user device.

10. The method as claimed in claim 8, wherein the determination is provided to a specified location.

11. The method as claimed in claim 1, further comprising the step of:
identifying a functional issue;
storing data related to the functional issue;
comparing the stored data related to the functional issue to previously stored data; and
determining a response to the functional issue.

12. The method as claimed in claim 1, further comprising:
obtaining second usage data after selected data is provided, to the user device, based on data analysis.

13. The method as claimed in claim 12, further comprising:
creating a second data file based on the obtained second usage data;
uploading the second data file from the user device to an external server device; and
performing a second data analysis of the second data file.

14. The method as claimed in claim 13, further comprising:
identifying whether selected data provided to user device based on data analysis improved user device performance.

15. The method as claimed in claim 13, further comprising:
providing second selected data to user device based on second data analysis.

16. The method as claimed in claim 1,
wherein the data analysis identifies a performance issue, and
the selected data provided to the user device based on the data analysis is troubleshooting data which performs a number of steps in an attempt to address the performance issue.

17. A client device comprising:
a user account module that stores use pattern data for a user, the use pattern data including operational parameter data of the client device;
a transmission module that transmits the use pattern data to a remote location;
a reception module that receives processed data, the processed data being a function of the use pattern data and the operational parameter data; and
a processor module that utilizes the processed data to modify operation of the client device based on the received processed data.

18. The client device as claimed in claim 17, further comprising:
a display unit that displays an indication of the operation of the client device.

19. The client device as claimed in claim 17, wherein the use pattern data is updated at a predetermined time interval.

20. The client device as claimed in claim 17, wherein the client device monitors a specified feature of the client device.
